(19) United States
(12) Patent Application Publication
(10) Pub. No.: US 2023/0225930 A1
(43) Pub. Date: Jul. 20, 2023

(54) DISPOSABLE, INFLATABLE DEVICE FOR STIMULATION OF MALE GENITALIA AND COLLECTION OF SEMEN

(71) Applicant: IDS Products, LLC, Pepper Pike, OH (US)

(72) Inventor: Seth Dragomer, Pepper Pike, OH (US)

(73) Assignee: IDS Products, LLC, Pepper Pike, OH (US)

(21) Appl. No.: 18/155,033

(22) Filed: Jan. 16, 2023

Related U.S. Application Data
(60) Provisional application No. 63/299,990, filed on Jan. 16, 2022.

(51) Int. Cl. A61H 19/00

(52) U.S. Cl. CPC A61H 19/32; A61H 2201/0103; A61H 2201/0107; A61H 2201/1688; A61H 2201/1695

(57) ABSTRACT

The present disclosure describes a sexual aid device for the stimulation of male genitalia and the collection of semen. Upon manufacture, the sexual aid device includes an uninflated inner chamber, an elongated extension extending from the inner chamber, and an inflation passage in fluid communication with the inner chamber for subsequent inflation of the device. Prior to inflation and use, the elongated extension is inserted into the inner chamber, where upon inflation the elongated extension forms an internal passageway that is isolated from the inner chamber and arranged to accommodate a user's penis. Once inflated, the inflation passage is sealed such that the air or other gases are captured in the inner chamber and the inner chamber remains inflated. After use, the passageway captures any ejaculated semen. The device is deflated in a manner that secures any semen within the device for subsequent retrieval for medical use or disposal.

### CROSS-REFERENCE TO RELATED APPLICATIONS

This application claims priority to pending U.S. Provisional Patent Application No. 63/299,990, titled “Disposable Inflatable Male Sex Organ Stimulation Device,” filed on Jan. 16, 2022, which is expressly incorporated by reference herein in its entirety.

### FIELD OF INVENTION

The present disclosure generally relates to a sexual aid device for the stimulation of male genitalia and the collection of semen ejaculated from male genitalia. More specifically, the present disclosure relates to a single use, inflatable sexual aid device that is arranged to stimulate male genitalia and collect semen for medical purposes or for the personal convenience of the user.

### BACKGROUND

There are a number of techniques and devices currently in use that are designed to stimulate male genitalia and/or collect semen ejaculated by a male. The most common technique is for the male to manually self-stimulate his genitalia and upon ejaculation collect semen in a cup or other open receptacle. While such a technique and device is simple and straightforward, it is not conducive to easy collection of semen. When used in a medical context, patients are often directed to an isolated room with various types of visual aids to assist in self-stimulation, where the ultimate collection relies heavily on the patient's coordination and self-control. Such a technique often leads to ineffective collection of semen. Other device currently available for a similar purpose do provide for a more controlled collection of semen; however, these devise are typically expensive and cumbersome to use and require subsequent cleaning and maintenance.

Therefore, there is a need for devices and methods of using such device that stimulate male genitalia and collect semen ejaculated from male genitalia that are relatively inexpensive and are effective and efficient in the collection of semen. Disclosed herein are such novel device and methods of using such devices.

### SUMMARY

The present disclosure describes a sexual aid device for the stimulation of male genitalia and the collection of semen. Prior to use, the device is inflated using air or another gas. Prior to inflation, the sexual aid device includes an uninflated inner chamber, an elongated extension extending from the inner chamber, and an inflation passage in fluid communication with the inner chamber and extending from the inner chamber opposite the elongated extension. Prior to inflation and use, the elongated extension is inserted into the inner chamber, where upon inflation the elongated extension forms an internal passageway that is isolated from the inner chamber. The device is inflated by passing air or other gases through the inflation passage and into the inner chamber. Once inflated, the inflation passage is sealed such that the air or other gases are captured in the inner chamber and the inner chamber remains inflated.

Once inflated and ready for use, the device is used by a user inserting the user's penis into the passageway and the user manipulating the sexual aid device to simulate sexual intercourse, which typically causes the user to ejaculate semen into the passageway. Upon such action, the user can deflate the sexual aid device by unsealing the inflation passage and allowing air or other gases to escape from the inner chamber. The user then removes his penis from the passageway of the device in such a manner that the semen remains in the passageway so that the passageway serves as a collection chamber that holds and isolates the semen. The excess material of the device can then be tied off in a manner that seals the semen in the passageway for either later extraction for medical use of the semen or to efficiently disposal of the captured semen.

### BRIEF DESCRIPTION OF THE DRAWINGS

In the accompanying drawings, structures are illustrated that, together with the detailed description provided below, describe example embodiments of the disclosed systems, methods, and apparatus. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 schematically illustrates an embodiment of a sexual aid device post-manufacture.

FIG. 2 schematically illustrates a cross-sectional view of the sexual aid device of FIG. 1 with an elongated extension inserted into an inner chamber.

FIG. 3 schematically illustrates a cross-sectional view of the sexual aid device of FIG. 1 inflated and ready for use.

FIG. 4 schematically illustrates an exemplary disc clip.

FIG. 5 schematically illustrates another embodiment of a sexual aid device post-manufacture.

FIG. 6 schematically illustrates a cross-sectional view of the sexual aid device of FIG. 4 with an elongated extension inserted into an inner chamber.

FIG. 7 schematically illustrates a cross-sectional view of the sexual aid device of FIG. 4 inflated and ready for use.

FIG. 8 schematically illustrates another embodiment of a sexual aid device post-manufacture.

FIG. 9 schematically illustrates yet another embodiment of a sexual aid device post-manufacture.

### DETAILED DESCRIPTION

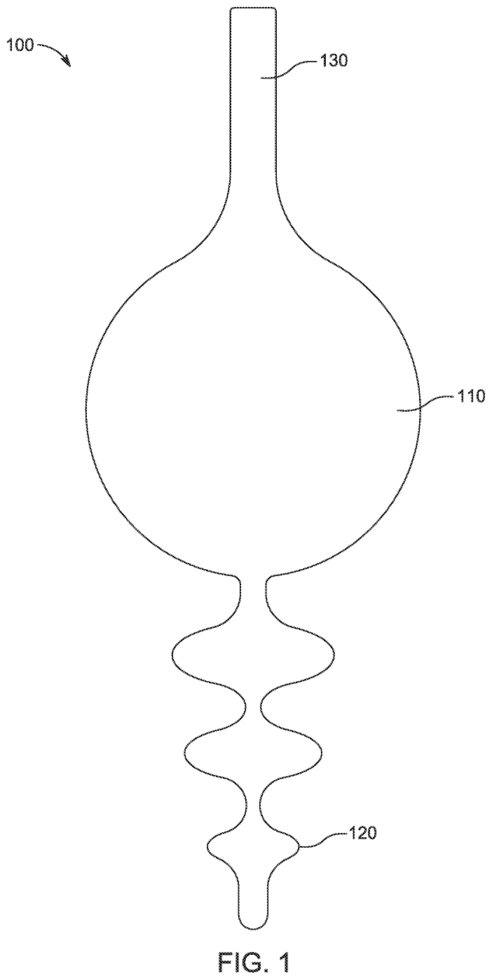

The apparatus, systems, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of sexual aid devices for the stimulation of male genitalia and the collection of ejaculated semen are hereinafter disclosed and described in detail with reference made to FIGS. 1-9.

Disclosed herein are exemplary devices arranged for use by a male that simulate intercourse with a female and collect semen ejaculated by the male upon using the device. Such devices can be useful for medical purposes and for the personal pleasure of a user. In one example, the user can be a medical patient that is asked to provide a semen sample to a doctor for either medical diagnosis or for use in a subsequent fertility procedure. In another example, the user can use the device for his own personal pleasure needs and subsequent efficient disposal of any ejaculated semen.

Generally, the sexual aid devices disclosed herein are designed to be single use, disposable, inflatable bladders that include an internal passage to accommodate the penis of a user. The devices are manufactured from an elastomeric material such as latex or nitrile using a dipping process similar to manufacturing processes for balloons, condoms, and gloves. Such a process includes using a form or mold that is dipped in or otherwise coated with an elastomeric material. Once the elastomeric material sets, the device is removed from the form or mold. Upon manufacture, the device includes an inner chamber, an elongated extension, and an inflation passage. To prepare the device for use, the elongated extension is subsequently positioned within the inner chamber. The device can then be inflated through the inflation passage to prepare the device for use. Such inflation of the device results in the elongated extension positioned within the inner chamber forming a passageway that can accommodate the penis of a user. Specific examples are described herein and illustrated in FIGS. 1-9.

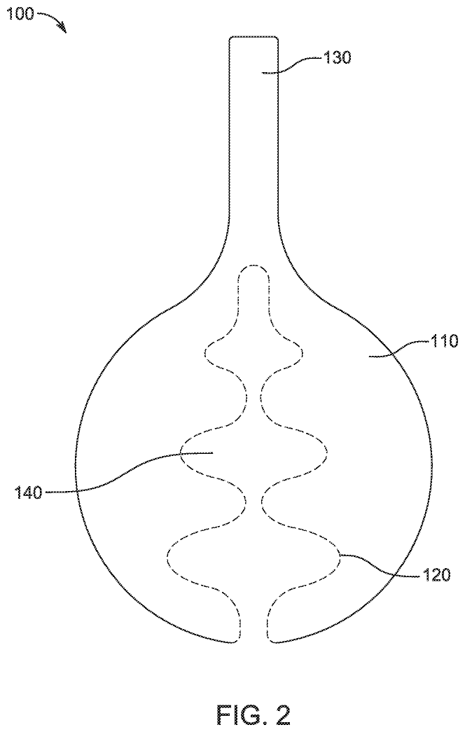

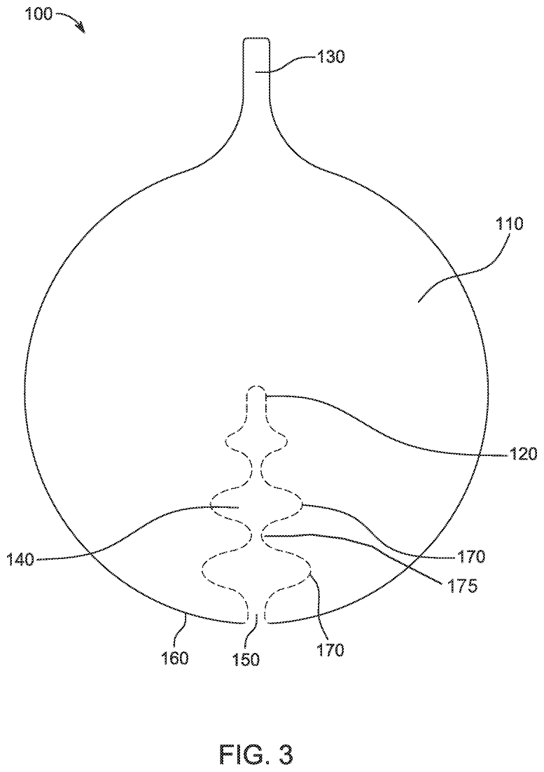

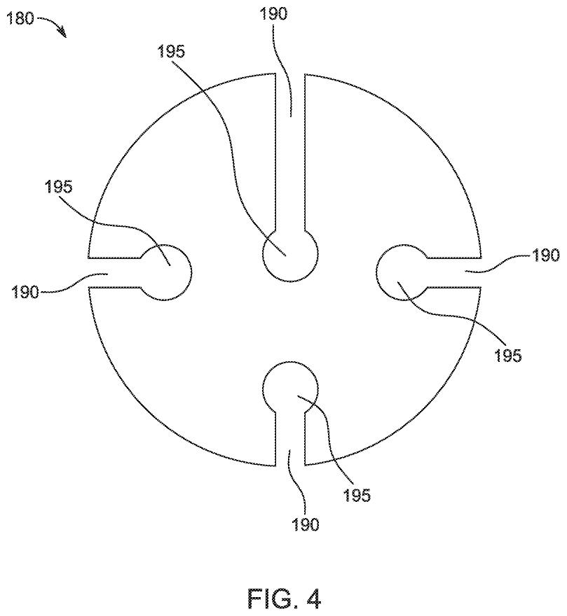

FIGS. 1-3 illustrate one exemplary embodiment of a sexual aid device 100, with each figure illustrating a different state of the sexual aid device 100. FIG. 1 illustrates the sexual aid device 100 after its manufacture and prior to inflation with an inner chamber 110 and an elongated extension 120 extending from the inner chamber 110. The sexual aid device 100 also includes an inflation passage 130 located opposite the elongated extensions and in fluid communication with the inner chamber. FIG. 2 illustrates the elongated extension 120 positioned within the inner chamber 110 to form the passageway 140 upon inflation of the sexual aid device 100. Once the sexual aid device 100 is manufactured, the device 100 can be packaged, stored, and/or shipped in either the configuration illustrated in FIG. 1 or the configuration illustrated in FIG. 2. When the user is ready to use the sexual aid device 100, the user can inflate the device 100 (as illustrated in FIG. 3) using the inflation passage 130. The sexual aid device 100 can be inflated by passing air or other gases through the inflation passage 130 and into the inner chamber 110. Once the device 100 is inflated to reach its desired size, the user can close or seal the inflation passage 130 by either tying off the passage 130, similar to a balloon, or by placing a clip on the inflation passage 130 to secure the air or other gases inside the inner chamber 110. One exemplary embodiment of a clip 180 is illustrated in FIG. 4. Such a clip 180 is often referred to as a disc clip and is arranged such that once the sexual aid device 100 is inflated, the inflation passage 130 can be inserted into one of the slots 190 until it is positioned in the respective circular cut out 195. Once the inflation passage 130 is positioned in the circular cut out 195, the inflation passage 130 will be sealed, and the sexual aid device 100 will remain inflated.

As illustrated in FIG. 3, the passageway 140 included an opening 150 in the center of a base 160 of the sexual aid device 100. It is noted that the opening 150 is smaller than the passageway 140. The opening 150 and passageway 140 are arranged to accommodate the insertion of the user's penis into the device 100. The passageway 140 is designed to simulate the tactile feel of a human orifice. The passageway 140 can include certain features 170, 175 to enhance such tactile feel. For example, as illustrated in FIG. 3, the passageway 140 can include a series of recessions 170 and protrusions 175 that can engage with a penis of a user during the simulation of a sexual act to stimulate the user. Once the penis is inserted into the passageway 140, the sexual aid device 100 can be manually and repeatedly moved toward and away the user's body to simulate a sexual act. The base 160 of the sexual aid device 100 is designed to simulate repeated contact between the user and a partner's body during such manual movement of the device 100 to assist in the stimulation of the user's genitalia.

As the sexual aid device 100 is used, the user typically becomes sufficiently stimulated to ejaculate into the passageway 140, which in essence transforms the passageway 140 into a semen collection and storage chamber. Upon such action, the sexual aid device 100 is deflated by the user. Deflation can be achieved by snipping the inflation passage 130 below the location where it was tied off or by unclipping the inflation passage 130 by removing the clip. Such action will allow the air or other gases in the inner chamber 110 to escape. Once deflated, the sexual aid device 100 can be removed from the penis in a manner that captures the semen within the passageway 140. The sexual aid device 100 can then be tied off or the clip can be reapplied to again secure the semen within the sexual aid device 100 for later medical use or for convenient disposal. As will be understood, when the sexual aid device 100 is ready to be removed from the penis, the user can in essence flip the device 100 inside out so that the passageway 140 becomes the inside section of the device, and the inflation passage 130 can be tied off or clipped to seal the semen in the inside section of the device 100.

The sexual aid device 100 as described and illustrated can be manufactured very inexpensively and provides a single use, disposable device that meets a need in the marketplace. As will be appreciated, such single use, disposable devices eliminate any clean up or maintenance that comes with a reusable device.

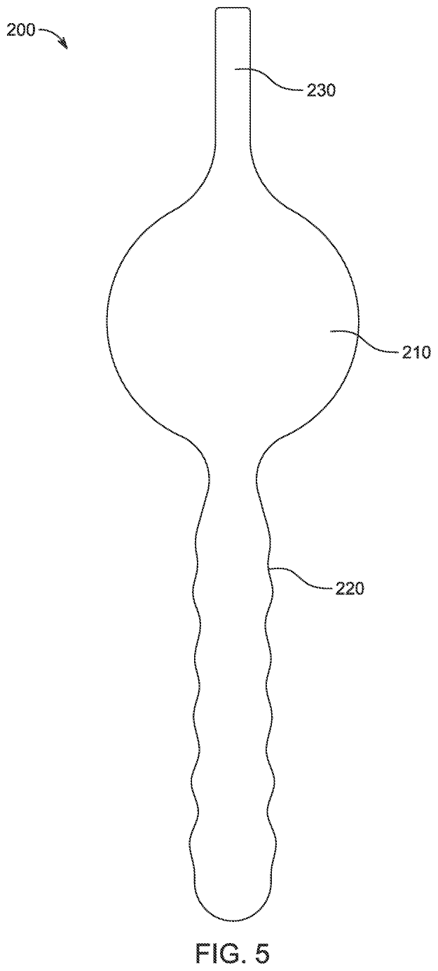

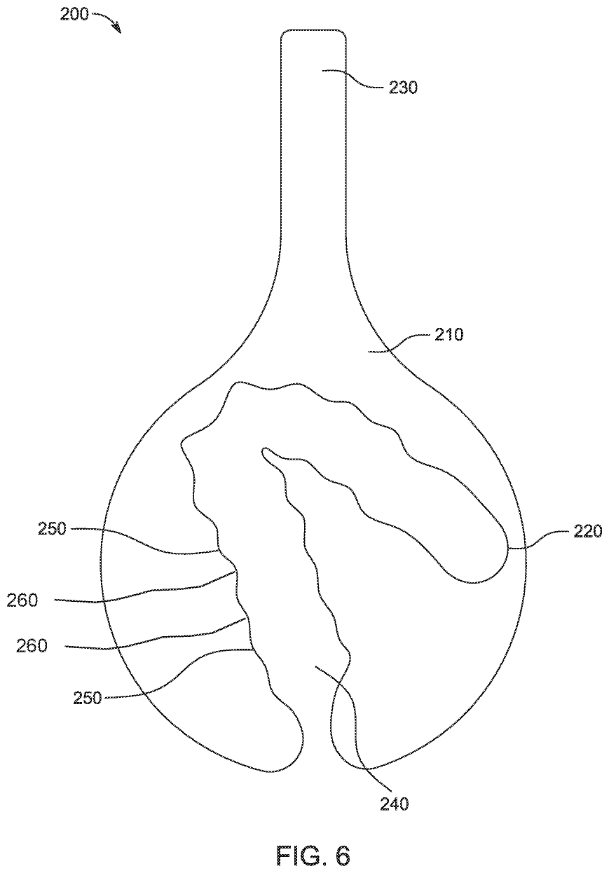

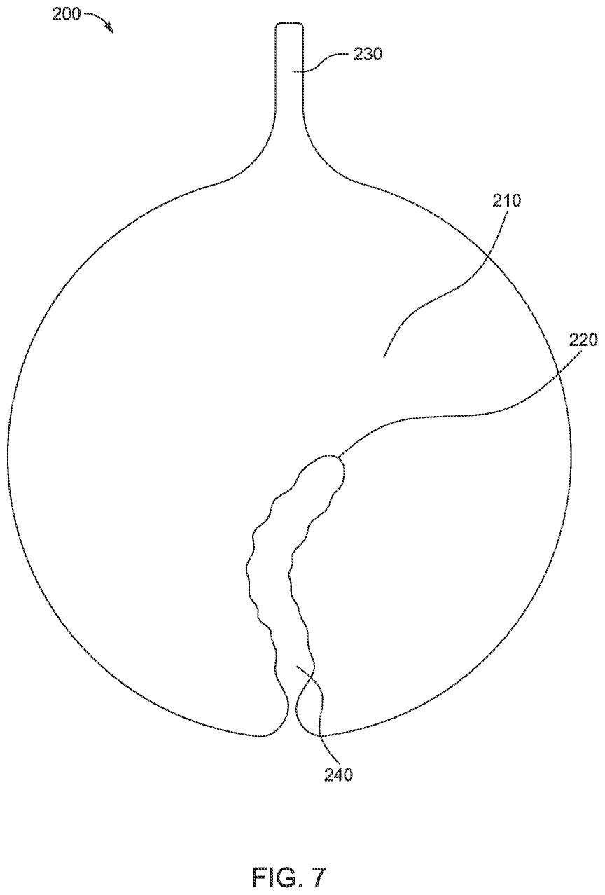

FIGS. 5-7 illustrate another exemplary embodiment of a sexual aid device 200. As with FIGS. 1-3, each figure illustrates a different state of the sexual aid device 200. FIG. 5 illustrates the sexual aid device 200 after its manufacture and prior to inflation with an inner chamber 210 and an elongated extension 220 extending from the inner chamber 210. The sexual aid device 200 also includes an inflation passage 230 located opposite the elongated extensions and in fluid communication with the inner chamber 210. FIG. 6 illustrates the elongated extension 220 positioned within the inner chamber 210 to form the passageway 240. FIG. 7 illustrates the sexual aid device 200 inflated and ready for use. It is noted that the passageway 240 is longer in this embodiment than in the embodiment illustrated in FIGS. 1-3. Additionally, the features 250, 260 designed to enhance such tactile feel of the passageway 240 are designed as a series undulation that form a series of ribs. The examples illustrated in FIGS. 1-7 are but two examples of sexual aid devices. Other variations are possible and understood to embody the principles of such devices disclosed herein.

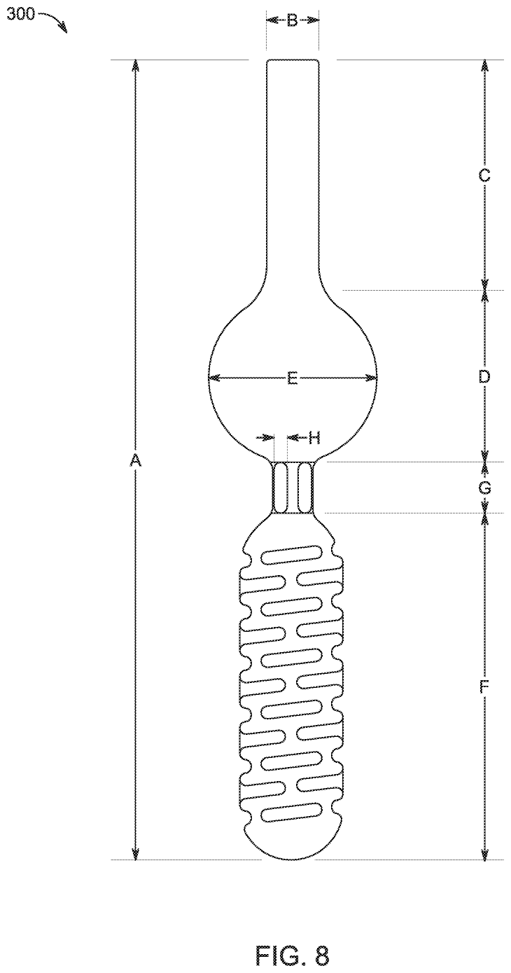

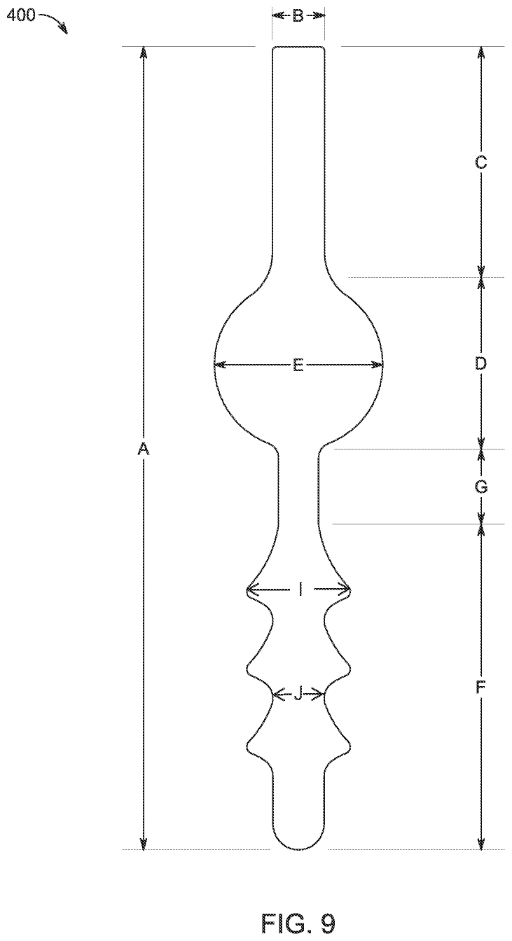

The relative dimensions of various sections of the sexual aid device upon its manufacture but prior to inflation are illustrated with reference to FIGS. 8 and 9. Both embodiments of the sexual aid device 300, 400 are similar; however, the elongated extensions have unique features. The features of the elongated section can be designed to provide a range of options to suit individual preferences of users. While features can be designed to create an experience that is similar to a sexual experience with another person, such features can also be designed to provide a range of stimulation of the user's genitalia from mild stimulation to aggressive stimulation. It will be understood that humans have a range of preferences and may prefer a wide variety of contours and textures when engaging with the passageway, thus the sexual aid device will benefit from a variety of features incorporated into the elongated extension.

In both embodiments, the overall length of the device (A) is approximately 15.5 inches. The inflation passage is approximately 4.5 inches long (C) and about 1 inch wide (B). The inner chamber is approximately 3.25 inches in diameter (D, E). The sexual aid device 300 of FIG. 8 includes a neck section (G) between the inner chamber and the elongated extension that is approximately 1 inch long. The sexual aid device 400 of FIG. 9 includes a neck section (G) between the inner chamber and the elongated extension that is approximately 1.5 inch long. The elongated section (F) of device 300 is approximately 6.75 inches long, and the elongated extension (F) of device 400 is approximately 6.25 inches long. The thickness of the walls of the sexual aid device (H) can be approximately 0.25 inches. In one example, upon inflation of the device, the diameter of the inner chamber is approximately 16 inches. The dimensions disclosed herein are exemplary only and any other dimensions that accomplish the goals as described herein are included in this disclosure. As illustrated in FIG. 9, the features of the elongated section can be a repeated pattern of recessions and protrusions. In this example, the recessions (I) have a diameter of approximately 2 inches and the protrusions (J) have a diameter of approximately 1 inch.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

I claim:

1. An inflatable single-use sexual aid device for stimulating male genitalia and collecting semen, prior to inflation the sexual aid device comprising:
an inner chamber;
an elongated extension extending from the inner chamber; and
an inflation passage extending from the inner chamber and opposite the elongated extension, where the inflation passage is in fluid communication with the inner chamber.

2. The sexual aid device of claim 1, wherein the elongated extension is arranged to be inserted into the inner chamber prior to inflation of the sexual aid device.

3. The sexual aid device of claims 2, wherein upon inflation:
the inner chamber inflates; and
the elongated extension inserted into the inner chamber forms a passageway internal to the inner chamber.

4. The sexual aid device of claim 3, wherein the passageway is not in fluid communication with the inner chamber.

5. The sexual aid device of claim 3, wherein the inner chamber is inflated by passing air or other gases through the inflation passage and into the inner chamber.

6. The sexual aid device of claim of claim 3, wherein the inflation passage is arranged to be sealed once the sexual aid device is inflated.

7. The sexual aid device of claim 6, wherein once the inflation passage is sealed, the inflation passage is arranged to be unsealed to deflate the sexual aid device.

8. The sexual aid device of claim 6, wherein the inflation passage is arranged to be sealed by tying off the inflation passage and is arranged to be deflated by snipping the inflation passage below the location that the inflation passage is tied off.

9. The sexual aid device of claim 6, wherein the inflation passage is arranged to be sealed by the application of a clip and is arranged to be deflated by removal of the clip.

10. The sexual aid device of claim 3, wherein the passageway includes a series of features.

11. The sexual aid device of claim 10, wherein the series of features include a plurality of protrusions and a plurality of recessions.

12. The sexual aid device of claim 10, wherein the series of features include a plurality of undulations that form ribs.
